(19) United States
(12) Patent Application Publication
(10) Pub. No.: US 2009/0055390 A1
(43) Pub. Date: Feb. 26, 2009

(54) INFORMATION SORTING DEVICE AND INFORMATION RETRIEVAL DEVICE

(75) Inventors: Shigenori Maeda, Kyoto (JP); Takashi Nishimori, Osaka (JP)

Correspondence Address: WENDEROTH, LIND & PONACK L.L.P., 2033 K. STREET, NW, SUITE 800, WASHINGTON, DC, 20006, US

(73) Assignee: MATSUSHITA ELECTRIC INDUSTRIAL CO., LTD., Osaka (JP)

(21) Appl. No.: 12/162,932

(22) PCT Filed: Jan. 31, 2007
(86) PCT No.: PCT/JP2007/051606

§ 371 Date: Jul. 31, 2008

(30) Foreign Application Priority Data
Feb. 1, 2006 (JP) 2006-025072

(51) Int. Cl. G06F 17/10; G06F 17/30

(52) U.S. Cl. 707/5; 707/E17.014

(57) ABSTRACT

An information retrieval device and the like are provided to quickly retrieve information desired by a user even when information is collected based on the user's taste or interest. Each of sort item generating units (121 to 12N) sorts information into plural sort items based on different sorting aspects (details or attributes of information), and a category generating unit (13) combines the sort items into various categories. A category-combination searching unit (14) combines a predetermined number of the categories to generate category combinations to which information of the most equivalent in number belongs. When information is narrowed down using the category combinations, the number of operations for arriving at target information to be retrieved by the user (specifically, the number of operations for selecting categories or for searching target information to be retrieved in the categories) can be minimized, thereby enabling much faster retrieval.

### TECHNICAL FIELD

The present invention relates to an information sorting device that sorts a large amount of information into plural categories according to details or attributes of the information, and to an information retrieval device that retrieves information based on the categories into which the information has been sorted.

### BACKGROUND ART

In recent years, as information diversifies and high-capacity storage mediums are developed, the number of pieces of information that is managed personally often becomes extremely large. Accordingly, an information retrieval device that can efficiently retrieve a large amount of information based on the details of information becomes increasingly important. Various methods for identifying information that a user desires to retrieve are utilized in the information retrieval device. Conventional methods which are generally used include: “a keyword-specifying method” with which a keyword to be used for retrieval is specified; “a rearrangement-pattern-specifying method” with which a pattern of displaying an information list is specified; and “a category selecting method” with which a category indicating information details is selected from a list.

In the keyword-specifying method, a user estimates a phrase included in the information to be retrieved, or a phrase attached as a tag to the information to be retrieved (retrieval-target information), in other words a key word, and inputs the keyword. In this case, target information can be obtained very quickly when the inputted keyword is appropriate. However, a keyword can be paraphrased, in general, into several other words. It is therefore often the case where matching is not possible or, even if possible, takes too much time for detailed checking since the keyword hits a large amount of information. Accordingly, it is difficult to estimate an appropriate keyword and the user cannot avoid a trial and error; therefore, retrieval is not always efficiently carried out.

Further, in the rearrangement-pattern-specifying method with which a rearrangement pattern is selected when information is displayed on a list, a user arbitrarily selects a rearrangement pattern from several prepared rearrangement patterns such as a rearrangement in an order of time and date of generating the information and in an order of the Japanese syllabary for the title, and rearranges the information on the information list. With the rearrangement-pattern-specifying method, when a large amount of information is included in the information list, information which does not appear near the top of the list in any rearrangement patterns increases; therefore retrieval cannot be carried out efficiently in many cases.

Whereas, there is a “category selecting method” as a method that allows retrieving a large amount of information even in the case where an appropriate keyword cannot be recalled. With the category selecting method, information is sorted into categories that are arranged, based on a semantic distance of details, to have a hierarchical structure, and a user follows the hierarchy and selects a category, thereby narrowing down information. In the category selecting method, a category structure that enables efficient retrieval differs according to information that the user owns or information designated as a target range for retrieval. Accordingly, techniques for automatically configuring the hierarchical structure of a category according to information that a user owns or information designated as a target range for retrieval have been proposed (see, for example, Patent References 1, 2, and 3).

In the Patent Reference 1, a technique has been proposed which presents categories tailored to a user within a limited area in a screen, by setting a degree of importance for each of categories that have a prepared hierarchical structure and selects only the categories having a high degree of importance. Further, the Patent Reference 2 has proposed a technique that generates a category indicating a topic by clustering a keyword extracted from a text based on a semantic relation and presents the generated categories in a map format having a hierarchical structure so as to be selected by a user.

On the other hand, with those techniques for automatically configuring a hierarchical structure for a category, the size of a generated category (the number of pieces of information included in the category) becomes significantly uneven between categories, deteriorating readability of a sorting result on a list. This leads to a problem of an increase in the number of operations or an increase in the amount of effort necessary to search target information to be retrieved in a category or select a category for narrowing down information. More specifically, when a category size is too large, a large amount of information is included in the category even after information has been narrowed down by selecting the category, resulting in difficulty in finding the target information to be retrieved. Conversely, when a category size is too small, a large number of categories are necessary for sorting all of the information into corresponding categories, posing a problem that it becomes difficult to select a category. In order to address the problem, Patent Reference 3 proposes a technique to reduce unevenness in the size of categories to be displayed to a user, by calculating a score based on the size of each category and the like after generating a hierarchical structure of the categories based on a semantic distance of information, determining a level with the highest total score, and selecting a predetermined number of categories having high scores in the level.

Patent Reference 1: Japanese Unexamined Patent Application Publication No. 09-297770 Patent Reference 2: Japanese Unexamined Patent Application Publication (Translation of PCT Application) No. 2001-513242 Patent Reference 3: Japanese Unexamined Patent Application Publication No. 2005-63157

### DISCLOSURE OF INVENTION

### Problems that Invention is to Solve

The conventional techniques of automatically generating a hierarchical structure of categories are based on a hierarchical structure configured according to a semantic distance between categories. Accordingly, abstractiveness of categories displayed in the same level to a user, in other words, an extent of concept indicated by categories is equalized. With the above-described sorting structure, it can be expected that abstractiveness of a category and the size of the category have a certain level of correlation with each other, for information collected generally so as to meet demands of a large number of people, such as information in a library or a catalogue of merchandise. Accordingly, unevenness of a category size can be sufficiently reduced by maintaining the abstractiveness of a category equalized.

For information collected based on a user's taste or interest, however, it is necessary to take into account unevenness of information arising from the user's taste or interest. More specifically, since, when the user has a stronger taste or interest in a field, a larger amount of information on the field is collected, the category that stores information on the filed in which the user has a strong taste or interest becomes too large, compared with categories that store other information, in order to maintain abstractiveness of the category as equalized. This will be described in detail below.

FIG. 1 illustrates an example of a user interface when a user selects a category. Here, the user is assumed to have a strong interest in soccer. First, numbers “5”, “24”, “12”, and “37”, each of which is the number of programs belonging to corresponding one of genres, “ground-based movie program”, “Broadcasting Satellite (BS) movie program”, “drama”, and “sport”, are presented together with the genres, as illustrated in FIG. 1 (A). When the user selects “sport” here, subgenres “baseball”, “soccer”, and “golf” each of which belongs to the sport are presented, as illustrated in FIG. 1 (B). Here, the number of programs belonging to “soccer” is 30, whereas the number of program belonging to “baseball” is 1 and “golf” is 0. In other words, a category that stores information on the field in which the user has a strong taste or interest becomes too large compared with categories that store other information.

As is apparent from the above, the conventional techniques of automatically generating a hierarchical structure of categories, which maintains the abstractiveness of a category as equalized, cannot avoid concentration of information on a certain category according to the intensity of the user's taste or interest, thereby making it impossible to sufficiently narrow down information when a retrieval. This entails a problem that high-speed and effective retrieval cannot be achieved due to the need to search a large amount of information for target information to be retrieved or the need to select a lot of categories for narrowing down the information.

The present invention has been conceived in view of the above problems, and aims to present: an information retrieval device capable of quickly retrieving information desired by a user; an information sorting device capable of effectively sorting information so as to allow high-speed retrieval; and the like, even in the case where a large amount of information is collected on a basis of the user's taste or interest.

### Means to Solve the Problems

In order to solve the above described problems, an information sorting device according to the present invention includes: an information storage unit in which information is stored; an information extracting unit that extracts details or attributes of the information stored in the information storage unit; at least one sort item generating unit that generates plural sort items based on the details or attributes of the information extracted by the information extracting unit; a category generating unit that generates a category by combining one or more of the sort items generated by the sort item generating unit; a category-combination covering amount measuring unit that measures a category-combination covering amount that is a total number of pieces of information that belongs to at least one of the categories composing a category combination obtained by combining a predetermined number of the categories generated by the category generating unit; a category-size measuring unit that measures a size of the category generated by the category generating unit; a category-combination searching unit that searches a category combination having a smallest square sum of the size of the category measured by the category-size measuring unit, from among the category combinations whose category-combination covering amount measured by the category-combination covering amount measuring unit matches the total number of pieces of information stored in the information storage unit; and a category holding unit that holds the category combination searched by the category-combination searching unit. This structure allows generation of sorting so as to include less unevenness in the size and less information overlapping between categories even in the case where a large amount of information is collected on a basis of the user's taste or interest, thereby enabling a high-speed retrieval while minimizing the number of operations for arriving at target information to be retrieved by the user (specifically, the number of operations for selecting categories from a category list or for searching and selecting target information to be retrieved in a list of information belonging to the selected category).

Here, the category-size measuring unit may use, as the size of the category, the number of pieces of information that belongs to the category. This makes possible the number of pieces of information belonging to each category to be even.

Further, the category-size measuring unit may use, as the size of the category, a sum of numeric values corresponding to a degree of importance of the information that belongs to the category. This allows a probability that information is viewed to be even between categories in the case where the probability that information is viewed has been employed as the degree of importance.

Further, the category generating unit may generate the category by taking a union of at least two sort items. This allows generating a category in which information to which a user does not have much strong taste or interest is stored, the category having high-level abstractiveness and being roughly categorized.

Further, the sort item generating unit may compose a broader term sharing group by combining sort items, to which information that includes details or attributes having the common broader term belongs; and the category generating unit may generate the category by identifying and combining the sort items belonging to the same broader term sharing group. This allows generating a category in which information to which a user does not have much strong taste or interest is stored, the category having high-level abstractiveness and being roughly categorized.

Further, the sort item generating unit may compose the broader term sharing group so as to have a hierarchical structure. This makes it possible, even when a category having high-level abstractiveness and being roughly categorized is generated, to subdivide the category.

Further, the category generating unit may generate the category by taking a product set of at least two sort items. This makes it possible to generate a subdivided category in which information to which a user has strong taste or interest is stored, the category having low-level abstractiveness.

Further, the information extracting unit may further extract, from the information storage unit, only details or attributes of the information belonging to the category in the case where the category combination held in the category holding unit includes the category to which more than a predetermined number of pieces of information belong. This makes it possible, in the case where a large category to which more than a predetermined amount of information belongs exists, to subdivide the category so as to have a predetermined size.

Further, the category combination searching unit may search, in addition to the category combinations in which a predetermined number of the categories generated by the category generating unit are combined, a combination in which one of the categories included in the category combination is replaced with an “others” category to which all of the information that does not belong to any of other categories belongs. This allows a category of “others” to be presented to a user, the category being simple and comprehensible.

Further, the category-combination searching unit may include a candidate category generating unit that generates a candidate category by searching, from among the categories generated by the category generating unit, a category that has a category size within a predetermined range, the category size being measured by the category-size measuring unit. This makes it possible to designate, as the candidate categories, only the categories having a category size within the predetermined range.

Further, the category-combination searching unit may further include: a candidate-category-group generating unit that generates a candidate category group by grouping the categories in which information belonging to the candidate category has a similar structure, the candidate category being generated by the candidate category generating unit; and a candidate-category-group selecting unit that generates a candidate category group combination by selecting a predetermined number of candidate category groups generated by the candidate-category-group generating unit, selects one of the candidate category group combinations whose category information covering amount measured by the category-combination covering amount measuring unit matches the total number of pieces of information stored in the information storage unit, and causes the category holding unit to hold the selected combination This makes it possible to partially replace a category presented to a user with another category efficiently at high speed, while maintaining the sorting structure having less unevenness in the size between categories.

Further, the candidate-category-group selecting unit, in the case where none of candidate category group combinations whose category-combination covering amount measured by the category-combination covering amount measuring unit matches the total number of pieces of information stored in the information storage unit exists, may select a candidate category group combination that has a largest category-combination covering amount, generate an “others” category to which information that is stored in the information storage unit and that does not belong to any of candidate categories is to belong, and cause the category holding unit to additionally hold the generated category This allows a category of “others” to be presented to a user, the category being simple and comprehensible.

Further, the category generating unit may generate a category by combining sort items of not exceeding a predetermined number. This enables generating a complicated category. Accordingly, it is possible, in the case where a part of the category combination presented to a user is not desirable to the user, to present the user another category combination in which the part is replaced with a category more desirable to the user.

An information retrieval device according to the present invention includes: an information storage unit in which information is stored; an information extracting unit that extracts details or attributes of the information stored in the information storage unit; a sort item generating unit that generates a plurality of sort items based on the details or attributes of the information extracted by the information extracting unit; a category generating unit that generates a category by combining one or more of the sort items generated by the sort item generating unit; a category-combination covering amount measuring unit that measures a category-combination covering amount that is a total number of pieces of information that belongs to at least one of the categories composing a category combination obtained by combining a predetermined number of the categories generated by the category generating unit; a category-size measuring unit that measures a size of the category generated by the category generating unit; a category-combination searching unit that searches a category combination having a smallest square sum of the size of the category measured by that category-size measuring unit, from among the category combinations whose category-combination covering amount measured by the category-combination covering amount measuring unit matches the total number of pieces of information stored in the information storage unit; and a category holding unit that holds the category combination searched by the category-combination searching unit; an inputting unit that receives, from a user, an instruction of designating a category; a display details arrangement unit that arranges one of or both of the category combination held in the category holding unit and information that belongs to a category received by a user via the inputting unit so that a list of the one of or both of the category combination and the information are displayed to the user; and a category display unit that displays, to the user, one of or both of the category combination and the information that have been arranged by the display details arrangement unit. This structure makes it possible to quickly retrieve information desired by a user even in the case where a large amount of information is collected on a basis of the user's taste or interest.

It is to be noted that the present invention can be embodied not only as an apparatus or a system, but also as a method including, as its steps, the characteristic components included in the apparatus. Further, it is obvious that the present invention can be embodied as a program which, when loaded into a computer, allows the computer to execute the steps. Further, it is apparent that a software product including such a program is included in a technical scope of the invention.

### EFFECTS OF THE INVENTION

With an information sorting device or an information retrieval device of the present invention, it is possible to minimize the number of operations performed by a user for arriving at target information to be retrieved, even in the case where a large amount of information is collected on a basis of the user's taste or interest, by flexibly sorting information, without bound by difference of abstractiveness between categories, into a hierarchical structure in which each level includes a predetermined number of categories with less unevenness or overlapping between the categories, thereby enabling high-speed retrieval.

### BRIEF DESCRIPTION OF DRAWINGS

FIGS. 1 (A) and (B) illustrates an example of a user interface when a user selects a category using a conventional technique.

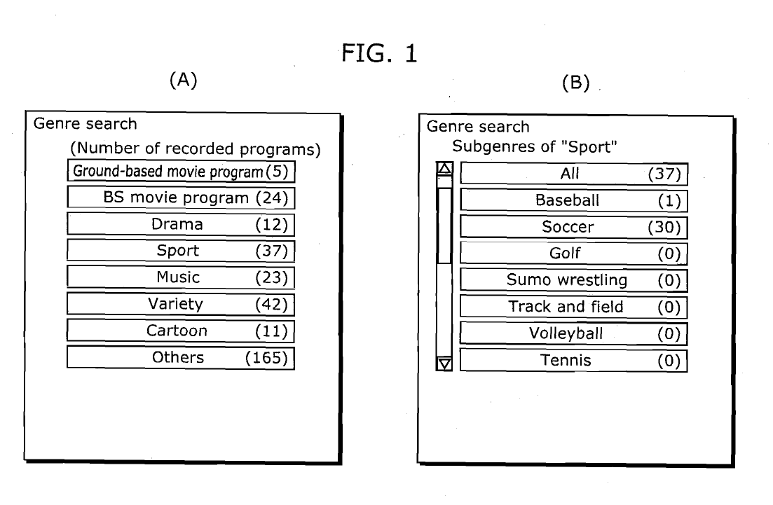

FIG. 2 illustrates a usage state of an information retrieval device according to the first embodiment.

FIG. 3 illustrates an overview of the present invention.

FIG. 4 conceptually illustrates a category generation process according to the present invention.

FIG. 5 is a block diagram illustrating a functional structure of the information retrieval device according to the first embodiment.

FIG. 6 illustrates a specific example of a sort item generation method according to the first embodiment.

FIG. 7 is a block diagram illustrating a more detailed functional structure of a category generating unit and a category-combination searching unit according to the first embodiment.

FIG. 8 is a flowchart illustrating a processing flow performed by the category-combination searching unit according to the first embodiment.

FIG. 9 illustrates an example of processing performed by the category generating unit according to the first embodiment.

FIGS. 10 (A) and (B) illustrates an example of a user interface when a user selects a category according to the first embodiment.

FIG. 11 illustrates an example of processing performed by the category generating unit according to the first embodiment.

FIG. 12 is a block diagram illustrating a functional structure of the information retrieval device according to the second embodiment.

FIG. 13 is a flowchart illustrating a processing flow performed by the candidate category generating unit according to the second embodiment.

FIG. 14 is a flowchart illustrating a processing flow performed by a candidate-category-group generating unit according to the second embodiment.

FIG. 15 is a flowchart illustrating a processing flow performed by a candidate-category-group selecting unit according to the second embodiment.

FIG. 16 (A) to (C) illustrates an example of a user interface when a representative category is changed according to the second embodiment.

### NUMERICAL REFERENCES

10 information storage unit
11 information extracting unit
121 to 12N sort item generating unit
13 category generating unit
14 category-combination searching unit
14a category-combination holding unit
14b combination evaluation unit
14c best category-combination holding unit
15 category-size measuring unit
16 category-combination covering amount measuring unit
17 category holding unit
18 display details arrangement unit
19 category display unit
20 inputting unit
100 information retrieval device
141 candidate category generating unit
142 candidate-category-group generating unit
143 candidate-category-group selecting unit
200 information retrieval device

### BEST MODE FOR CARRYING OUT THE INVENTION

Embodiments according to the present invention will be described below with reference to the drawings. It is to be noted that, although the present invention will be described with following embodiments and the drawings, they are intended not for the purpose of limitation but for exemplification only.

### First Embodiment

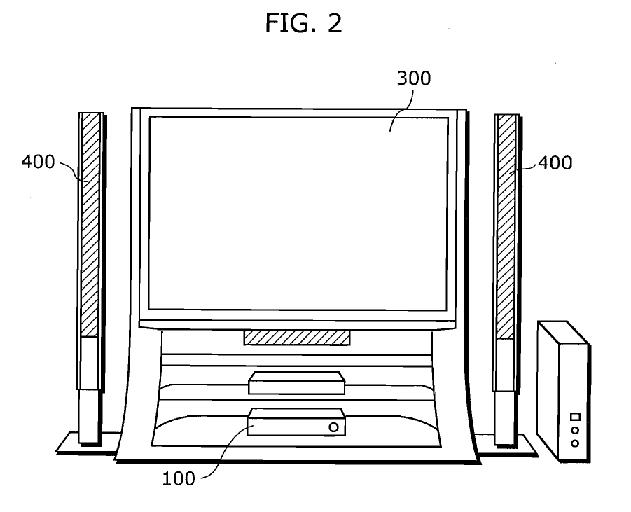

FIG. 2 illustrates a usage state of an information retrieval device 100 according to the present embodiment. As illustrated in this diagram, the information retrieval device 100 according to the present embodiment can be embodied as a DVD recorder. It is assumed that information collected on a basis of the user's taste or interest (for example, moving image data, still image data, document data, music data, audio data, and so on) is stored in the DVD recorder. The information stored in the DVD recorder can be outputted to a television 300 or an external speaker 400.

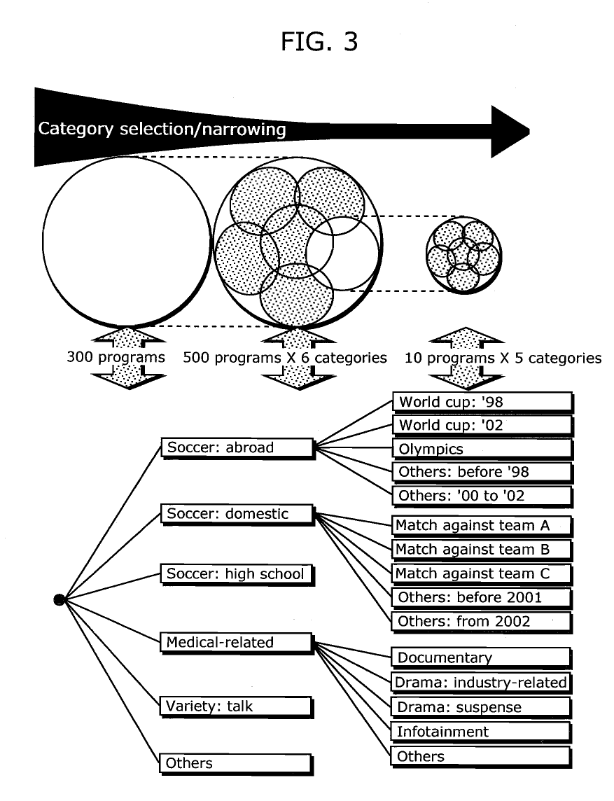

FIG. 3 illustrates an overview of the present invention. The present invention includes a technique relates to a category selecting method and a technique which minimize the number of operations for finding a target program. In the case where 300 programs are present as illustrated in FIG. 3, for example, the 300 programs are sorted into 6 categories each of which includes 50 out of the 300 programs, and the 50 programs belonging to each of the categories are further sorted into 5 sub categories each of which includes 10 out of the 50 programs. This makes it possible to narrow the programs down to 10 programs by selecting a category only two times. It is important here to ensure that the categories are comprehensible. In the case where 300 programs are sorted into 6 categories each of which includes 50 out of the 300 programs, for example, each category needs to be meaningful category to a user (comprehensible category). Six categories, “soccer: abroad”, “soccer: domestic” “soccer: high school”, “medical-related”, “variety: talk”, and “others”, are included in the first level, each of which is meaningful and comprehensible.

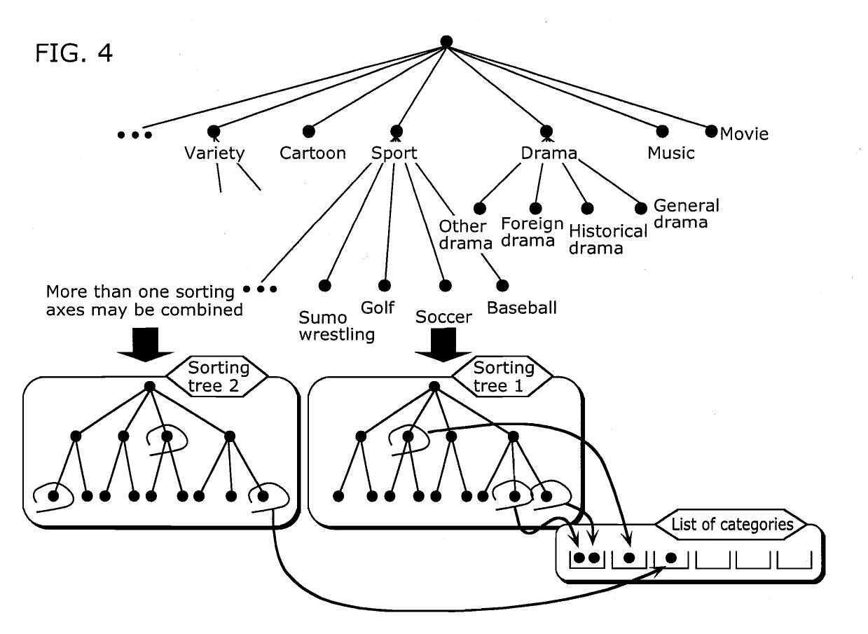

FIG. 4 conceptually illustrates a category generation process. As illustrated in this diagram, a category is generated, in the present invention, using sort items arranged in advance. A sort item is a set of programs gathered by a common characteristics. As described in detail below, a large category can be generated by taking a union of sibling sort items and a small category can be generated by taking a product set of sort items. As a result, it is possible to generate six categories so that the number of programs included in each category becomes even.

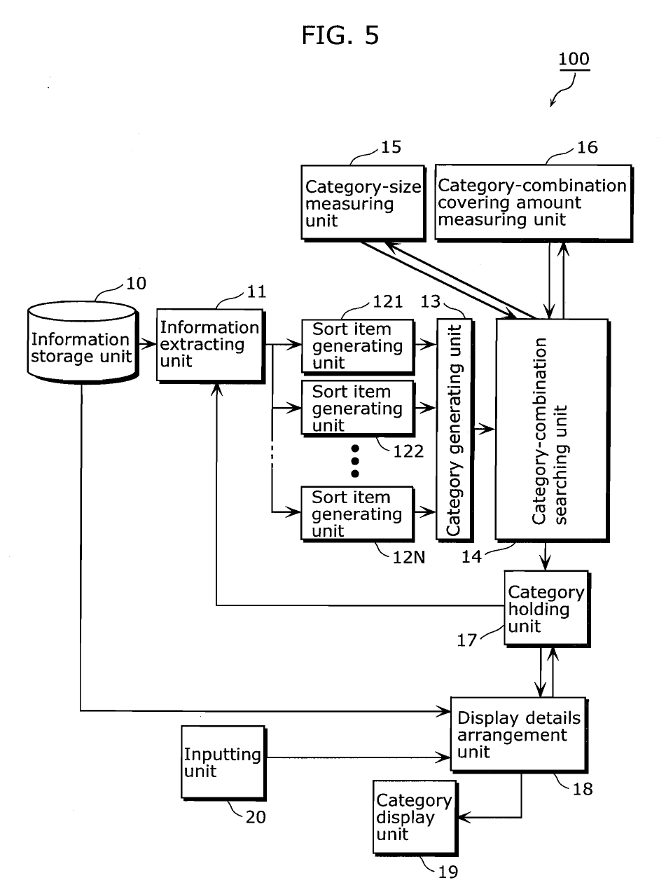

FIG. 5 is a block diagram illustrating a functional structure of the information retrieval device 100 according to the present embodiment. In FIG. 5, the information retrieval device 100 is an information retrieval device that enables high-speed retrieval while minimizing the number of necessary operations and includes: an information storage unit 10; an information extracting unit 11; sort item generating units 121 to 12N; a category generating unit 13; a category-combination searching unit 14; a category-size measuring unit 15; a category-combination covering amount measuring unit 16; a category holding unit 17; a display details arrangement unit 18; a category display unit 19; and an inputting unit 20.

The information storage unit 10 is an example of an information storage unit according to the present invention. More specifically, the information storage unit 10 is a recording medium of various types (for example, a hard disk device, a flush memory, a removable medium, and the like) and stores information of various types (for example, moving image data, still image data, document data, music data, audio data, and so on). A description will be given below as taking, as an example, the case where the information type is music data. It is to be note that the present invention can be applied not only to the case where only a single type of information is present, but also to the case where plural types of information are present.

The information extracting unit 11 is an example of an information extracting unit according to the present invention. More specifically, the information extracting unit 11 extracts, from music data stored in the information storage unit 10, music data in a target range for retrieval in which retrieval-target music data is included, and outputs the extracted music data to the sort item generating units 121 to 12N. In this case, not the entire music data that belongs to the group, but only the details or attributes of each music data (for example, a title, a genre, a performer name, a songwriter name, and a composer name of the music data, and the like) may be extracted and outputted to the sort item generating units 121 to 121N. It is to be noted that the attribute data may be extracted from, for example, a Compact Disc Data Base (CDDB) which is a database of attribute information of music data.

The sort item generating units 121 to 121N are examples of the sort item generating unit according to the present invention. More specifically, each of the sort item generating units 121 to 121N sorts music data inputted from the information extracting unit 11 into a large number of sort items based on different aspects (for example, a title, a genre, a singer name, a songwriter name, and a composer name of the music data, and the like). It is allowed here that music data may mutually overlap between sort items. In other words, it is assumed that single music data may belong to two or more sort items at the same time.

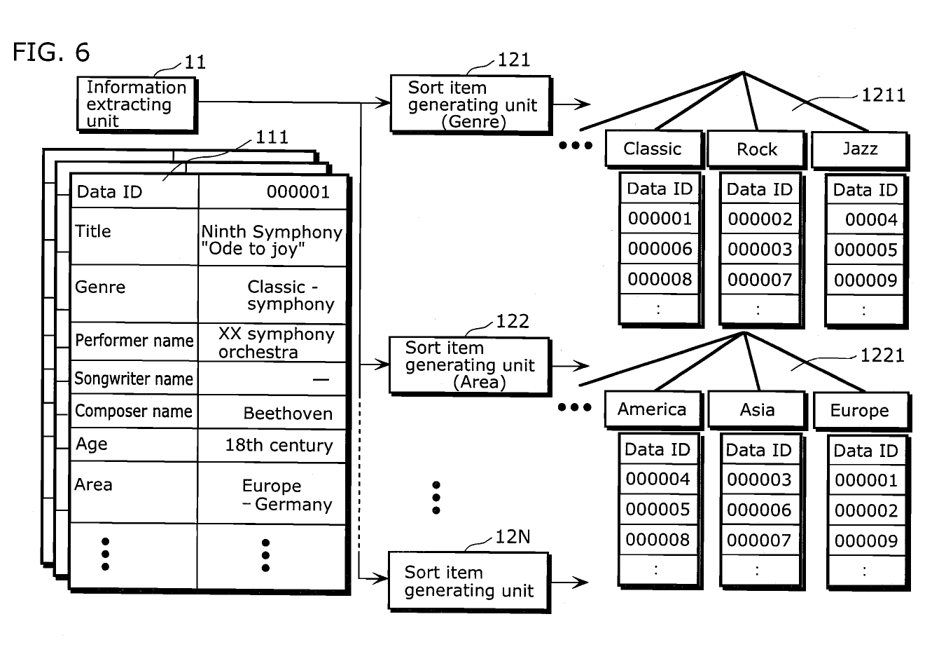

FIG. 6 illustrates a specific example of the method of generating sort items. The information extracting unit 11 extracts attribution data 111 of each music data. A data ID is assigned to attribution data of each music. A type of attribution data includes, as described above, a title, a genre, a performer name, a songwriter name, and a composer name, an area, an age, and so on. In each attribution data 111, although at least one type needs to have a value, it is not necessary for all types to have a value. The attribution data 111 extracted by the information extracting unit 11 is transmitted to the sort item generating units 121 to 12N. Each of the sort item generating units 121 to 12N reads the attribution data 111 of each music data and generates appropriate sort items. In the case of FIG. 6, the sort item generating unit 121 generates sort items regarding the attribute “genre”. To be specific, since the attribute “genre” of the music data having the data ID “000001” is “Classic”, a sort item “Classic” is generated as shown by 1211 and the data ID “000001” is added to the data list which belongs to the sort item. The sort item generating unit 122 generates sort items regarding the attribute “area”. To be specific, since the attribute “area” of the music data having the data ID “000001” is “Europe”, a sort item “Europe” is generated as shown by 1221 and the data ID “000001” is added to the data list which belongs to the sort item.

The sort items generated by the sort item generating units 121 to 12N are outputted to the category generating unit 13. The category generating unit 13 is an example of the category generating unit according to the present invention. More specifically, the category generating unit 13 generates various categories by selecting a sort item or combining plural sort items and outputs the generated category to the category-combination searching unit 14.

The category-combination searching unit 14 is an example of the category-combination searching unit according to the present invention. More specifically, the category-combination searching unit 14, in the case where all the music data extracted by the information extracting unit 11 belongs to any of the categories, searches a combination in which the categories are the most even in size, among category combinations in which the number of categories is predetermined (hereinafter, the number of categories is assumed to be C). Here, the size of a category (in other words, a category size) refers to the number of pieces of music data that belongs to the category.

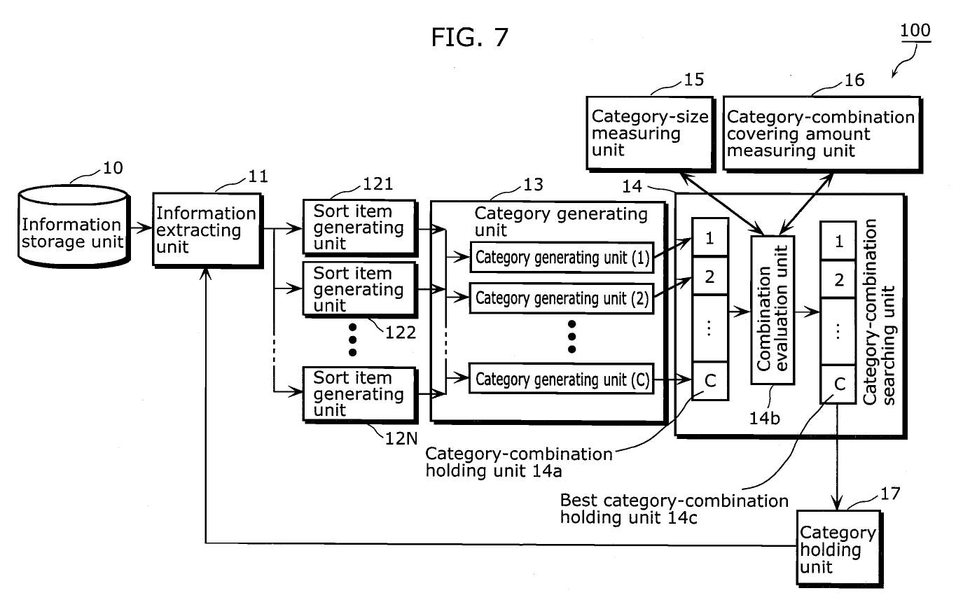

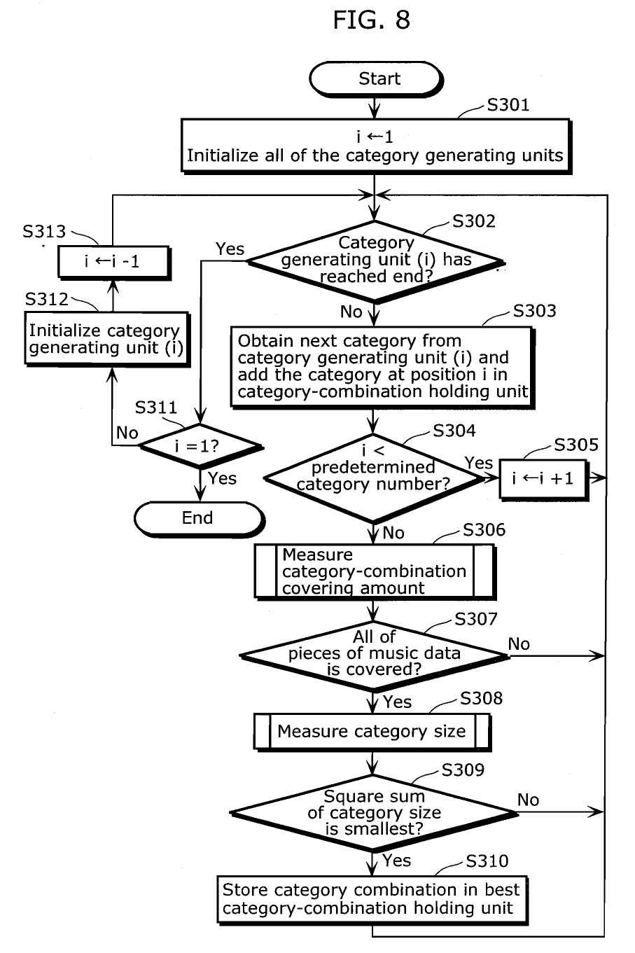

Next, a process performed by the category-combination searching unit 14 for generating C categories will be described with reference to FIG. 7 and FIG. 8. FIG. 7 is a block diagram illustrating a more detailed functional structure of the category generating unit 13 and the category-combination searching unit 14. Further, FIG. 8 is a flowchart illustrating a processing flow performed by the category-combination searching unit 14.

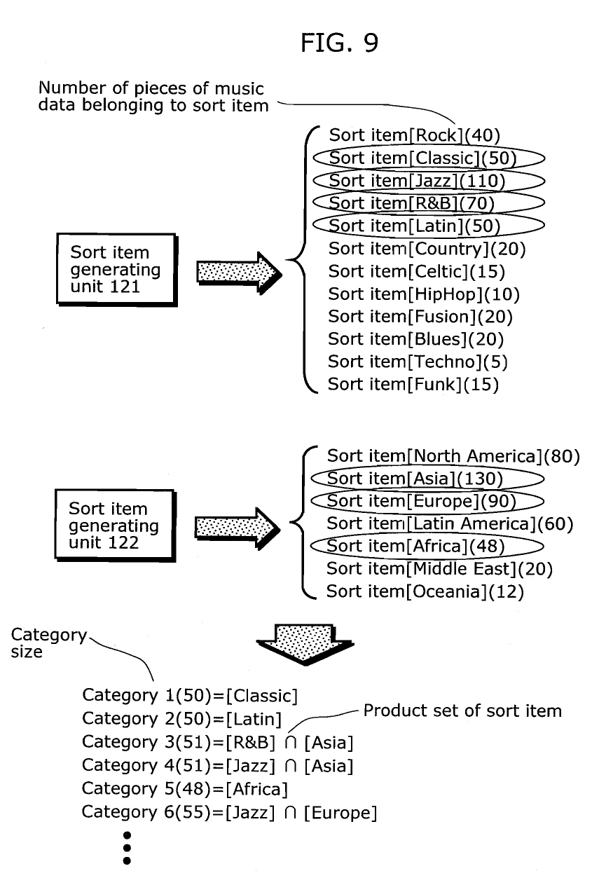

First, the category generating units (1) to (C) are initialized (Step S301). More specifically, an index “i” is initialized to be “1”. The index “i” indicates what number of category, among C categories to be generated, is being examined. The category generating unit 13 sequentially generates, as a candidate for the first to Cth category, a combination comprising at least one but no more than M sort items outputted from the sort item generating units 121 to 12N. Here, in the process of combining sort items in the category generating unit (i), as illustrated in FIG. 9 for example, it is assumed that a category to which fewer pieces of music data than those included in a single sort item belong, is generated by taking a set of music data that commonly belongs to any of at least two sort items (this is referred to as “product set”). A category to which more pieces of music data than those included in a single sort item belong, may be generated not by taking product set but by taking a set of music data that belongs to one of at least two sort items (this is referred to as “union”).

Next, whether or not the category generating unit (i) has reached an end is examined (Step S302). In the case of not reaching the end, a next combination of sort items is obtained from the category generating unit (i) and stored at the ith position in the category-combination holding unit 14a (Step S303). Further, whether or not the index i has reached the Cth is examined (Step S304). In the case of not reaching the Cth, the index i is incremented (Step S305) and the process goes back to S302.

In the case where the index i is judged to have reached the Cth in Step S304 (Step S304: Yes), the category-combination holding unit 14a has a combination of C categories.

Next, the combination evaluation unit 14b outputs the category combination held in the category-combination holding unit 14a to the category-combination covering amount measuring unit 16, where a total number of pieces of music data that belong to any one of the categories is calculated (S306). Next, whether or not the total number matches a total number of pieces of music data extracted by the information extracting unit 11 and designated as a target range for retrieval (in other words, whether or not the category combination held in the category-combination holding unit 14a covers all of the pieces of music data designated as the target range for retrieval), is examined (S307). In the case they do not match, the category combination held in the category-combination holding unit 14a is regarded as mismatch and discarded, and the process goes back to S302 and the next category combination is examined. It is to be noted that, although whether or not the total number matches the total number of pieces of music data extracted by the information extracting unit 11 and designated as a target range for retrieval is assumed to be examined in S307, whether or not a total number of pieces of music data recorded on the information storage unit 10 matches may be examined.

In the case where the category combination held in the category-combination holding unit 14a is judged to cover all of the pieces of music data designated as the target range for retrieval (S307: Yes), the combination evaluation unit 14b causes the category-size measuring unit 15 to calculate a category size of each of the categories which make up the category combination held in the category-combination holding unit 14a, and calculates the square sum (S308). Next, whether or not the square sum of the category size calculated in Step S308 is smaller than that of other category combinations that have already been examined is examined (S309). In the case where it is the smallest, the category combination held in the category-combination holding unit 14a is held in the best category-combination holding unit 14c (S310).

In the case where the category generating unit (i) has reached the end in the above-described Step S302, it is examined that whether or not the index i indicates the first category (S311). In the case where the first category is indicated, the process ends as all of the category combinations are regarded to have been examined. In the case where the index i does not indicate the first category, the category generating unit (i) is initialized and instructed to perform outputting again starting from the first category (S312), and then (i−1)th category is replaced and index i is decremented so as to generate a next category combination, and the process goes back to Step S302.

When the above-described processes are completed, the category-combination searching unit 14 outputs, to the category holding unit 17, the category combination held in the best category-combination holding unit 14c to be held therein. In the case where the number of pieces of music data that belong to each of the categories making Lip the held category combination is larger than a predetermined number, the category holding unit 17 instructs the information extracting unit 11 to set the music data belonging to each of the categories as a new target range for retrieval. After that, a category combination in which each category is further subdivided is held in the category holding unit 17 by repeating the above-described processes. With this, the category holding unit 17 has a hierarchical structure having levels each of which includes C categories.

It is to be noted that the process of generating the hierarchical structure of categories does not have to be performed each time a user starts retrieval. Once the hierarchical structure is generated, for example, it is sufficient to perform only when equal to or more than a certain number of changes (adding or deleting music data, changes in attributes) arise in the music data stored in the information storage unit 10. Further, in the case where changes in the music data stored in the information storage unit 10 cannot be detected, it may be possible to perform every time a certain period of time passes after the hierarchical structure is generated.

Next, the display details arrangement unit 18 is an example of a display details arrangement unit according to the present invention. More specifically, the display details arrangement unit 18 reads C categories in the highest level from the category combination held in the category holding unit 17 and arrange the categories so as to be read on a list. The category display unit 19 is an example of a category display unit according to the present invention. More specifically, the category display unit 19 displays the arranged C categories so that a user can select at least one of the C categories.

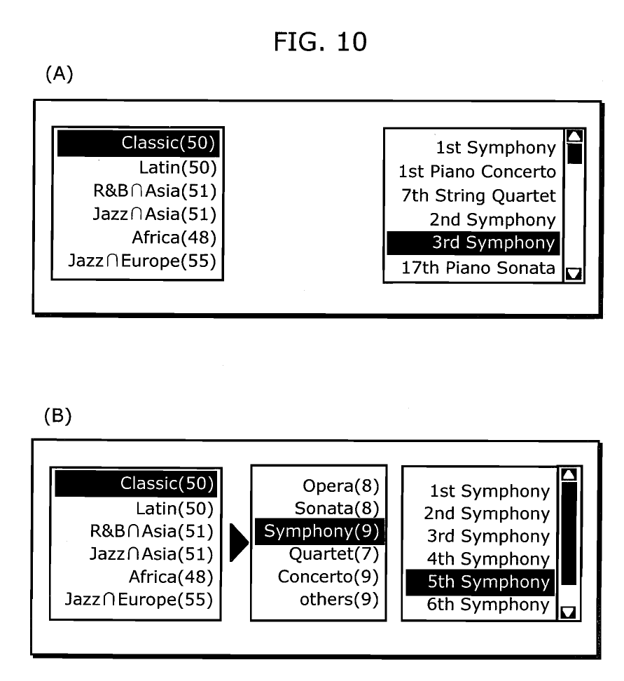

FIG. 10 (A) illustrates an example of an arrangement of category combinations. FIG. 10 (A) illustrates a case where the category holding unit 17 stores the category combination including “Classic” to “Jazz∩Europe” and “Classic” is displayed inverted as the category selected by a user. As illustrated in this diagram, the display details arrangement unit 18, when the inputting unit 20 receives an instruction for changing the selected category from the user, changes the category according to the instruction for changing the selected category.

It is to be noted that, as illustrated in FIG. 10 (A), not only the category combination but also the pieces of music data “1^{st} Symphony” to “17^{th} Piano Quartet” that belong to the currently selected category “Classic” (in this case, 7^{th} to 50^{th} pieces of music are not indicated) may be displayed in a list. This allows the user to easily understand the details of the selected category. Further, the number of pieces of music data that belongs to the category may be displayed together with the name of the category. For example, “Classic (50)” in FIG. 10 (A) indicates that the number of pieces of music data that belongs to “Classic” is 50. This allows the user to easily grasp, by selecting the category, to what degree the music data can be narrowed down.

Next, the display details arrangement unit 18 obtains, from the category holding unit 17, a category combination in a lower level which has been generated by subdividing the currently selected category, according to an instruction to subdivide the category, which the inputting unit 20 received from the user. Next, the display details arrangement unit 18 arranges the obtained category combination in a lower level to be viewed in a list by the user, and displays the arranged category combination on the category display unit 19 to be presented to the user. This allows the user to hierarchically select a category and quickly narrow down music data to be small number of pieces of music data.

FIG. 10 (B) illustrates an example of an arrangement of category combinations in the display details arrangement unit 18. FIG. 10 (B) illustrates a case where the category holding unit 17 further stores the category combination “Opera” to “others” and the “Symphony” is displayed inverted as the category selected by a user. Further, as well as FIG. 10(A), the pieces of music data “1^{st} Symphony” to “6^{th} Symphony” that belong to the selected category “Symphony” are also arranged.

It is to be noted that, as illustrated in FIG. 10 (B), the category combination “Classic” to “Jazz∩Europe”, which is the category combination before subdividing (in an upper level) may also be arranged. This allows the user to grasp a selection history at a glance, thereby facilitating searching the category including re-selection of an upper-level category.

With the above-described structure, music data is to be organized by being sorted into categories that make up a hierarchical structure, where the size of a category becomes the most even in each level, even in the case where the music data stored in the information storage unit 10 has been collected on a basis of the user's taste or interest. Accordingly, it is possible to achieve the information retrieval device that enables minimizing the expected value of the number of categories and pieces of music data that are presented as options until the user arrives at the retrieval-target music data and that allows the user to retrieve the retrieval-target music data at high speed.

It is to be noted that, although the number of pieces of music data that belong to a category is used when the category-size measuring unit 15 measures the size of the category, a sum of numeric value according to the degree of importance of information that belongs to the category may be used. For example, in the case where the probability of each of the music data to be the retrieval target is not even and the probability distribution can be estimated, a value of the sum of the estimated value of the probability, in the category, for each of the music data to be the retrieval target may be used. In this case, music data which is frequently retrieved can be retrieved with smaller number of options.

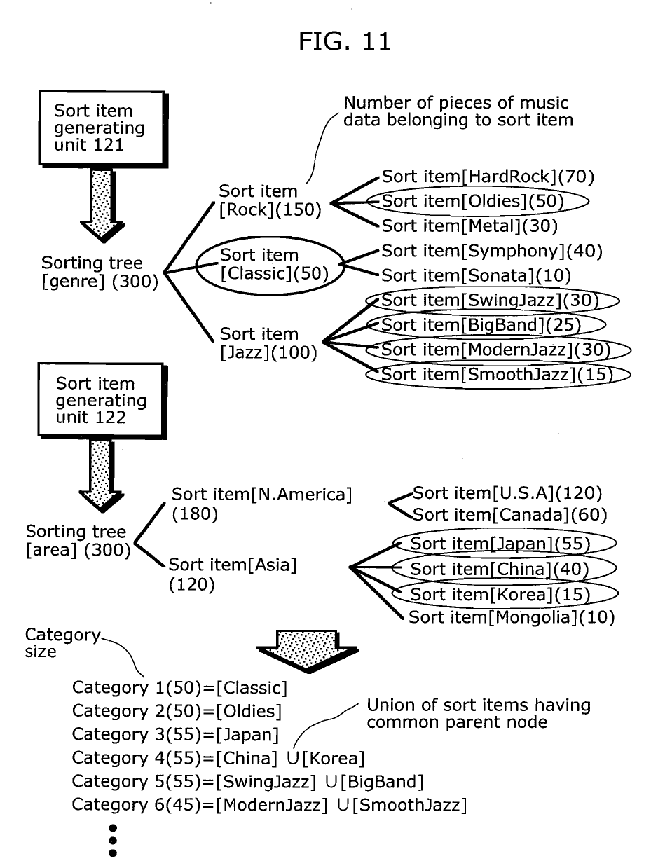

Further, although it is assumed in the above description that the category generating units (1) to (C) in the category generating unit 13 can arbitrarily combine sort items generated by the sort item generating units 121 to 12N, the present invention is not limited to this. For example, as illustrated in FIG. 11, regarding the sort items generated by the sort item generating units 121 to 12N, a broader term sharing group is configured by combining sort items to which the pieces of music data that have details or attributes sharing the same broader term belongs, and each group is arranged in a hierarchy to have a tree structure. In the case where the category generating units (1) to (C) combine the sort items, it may be possible to obtain a union of sort items that has a common parent node in the tree structure, in other words, the sort items that share the broader term (in FIG. 11, for example, the sort item [Swing Jazz] to the sort item [Smooth Jazz] that share the sort item [Jazz] that is the common parent node, and the like). This makes it possible to limit the categories generated by the category generating units (1) to (C) to be the broader term of the sort items related with each other, thereby making the category generated by the category-combination searching unit 14 easier for the user to understand.

Further, although it is assumed in the above description that the combination evaluation unit 14b evaluates the category combination including C categories obtained from the category generating unit 13, the present invention is not limited to this. For example, it may be possible that the combination evaluation unit 14b also evaluates a category combination which has the category “others” replaced from one of the categories making up each of category combinations, such as the category stored at Cth place in the category combination holding unit 14a, the “others” having music data that does not belong to any of the remaining (C−1) categories. With this, even in the case where music data that does not belong to any of the sort items exists, the data belongs to the category “others”. Accordingly, an appropriate category combination can be found more reliably. Further, the category combination can be simpler and easier to understand, since a complicated category in which quite a lot of sort items are combined is replaced by the category “others”.

Further, as illustrated by the flowchart in FIG. 8, a full search algorithm for searching all of the searchable category combinations is used for the process of searching category combination performed by the category-combination searching unit 14, the present invention is not limited to this. For example, the searching process may be performed to optimize the combination by searching the category combination where the square sum of the category size is minimized under the condition that all of the information in the target range for retrieval is covered. In this case, for example, the process of searching a category combination may be speeded up by using known algorithms such as branch and bound method or approximate means as described in “Nishikawa Yoshikazu, Sannomiya Nobuo, Ibaraki Toshihide, “Iwanami Koza Joho Kagaku 19 Saitekika” Iwanamishoten, 1982”.

### Second Embodiment

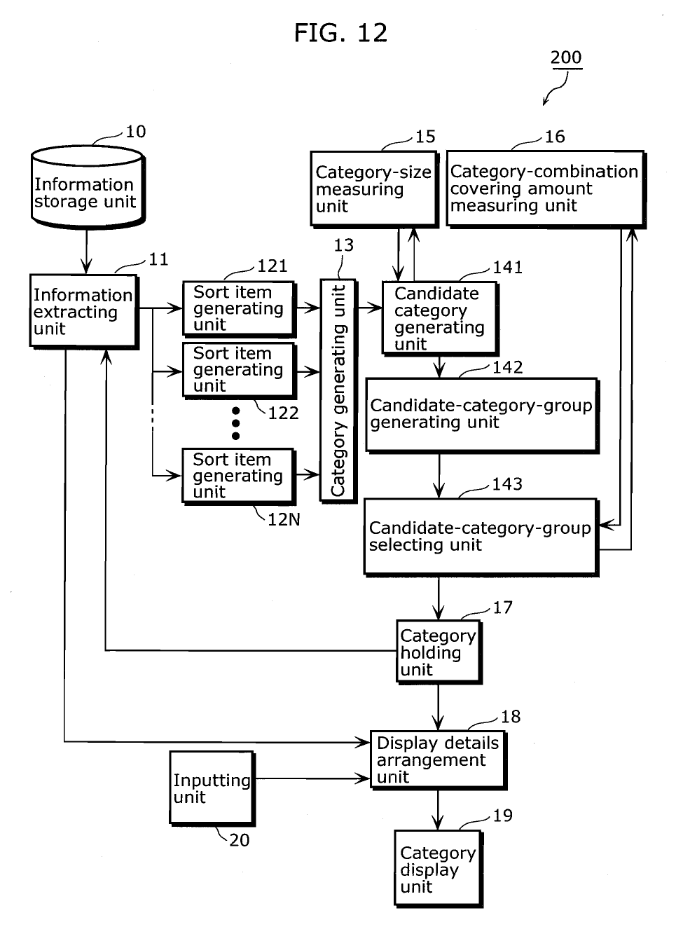

FIG. 12 is a block diagram illustrating a functional structure of the information retrieval device 200 according to the second embodiment. In FIG. 12, components having the same function with those in FIG. 5 of the first embodiment have the same numeral references as those in FIG. 5 and description thereof will be omitted. Further, music data will be taken as an example of information to be handled as in the first embodiment.

The information retrieval device 200 is a device that enables partially replacing a category displayed to a user with another category while maintaining a sorting structure with less unevenness in the size of the categories effectively at high speed. The information retrieval device 200 includes: an information storage unit 10; an information extracting unit 11; sort item generating units 121 to 12N; a category generating unit 13; a candidate category generating unit 141; a candidate-category-group generating unit 142; a candidate-category-group selecting unit 143; a category-size measuring unit 15; a category-combination covering amount measuring unit 16; a category holding unit 17; a display details arrangement unit 18; a category display unit 19; and an inputting unit 20.

The category generating unit 13 generates a category by combining sort items generated by the sort item generating units 121 to 12N as in the above-described first embodiment. Here, the candidate category generating unit 141 sequentially reads the categories generated by the category generating unit 13, selects the category that satisfies a condition for being the category to be finally displayed to the user, and outputs the selected category as a candidate category. The “condition for being the category to be finally displayed to the user” means that a total number of pieces of belonging music data is within a specified range and the number of the sort items which compose the category is equal to or fewer than a predetermined number. The total number of pieces of belonging music data is limited within the specified range, so that the unevenness of the number of belonging pieces of music between categories becomes equal to or lower than a certain level. Preferably, the specified range is set to include the number that the total number of pieces of the retrieval-target information extracted by the information extracting unit 11 is divided by C that is the number of category to be generated.

It is to be noted that, as a method of calculating the total number of pieces of belonging music data, it is possible to make categories easier to understand for a user, by taking either union or product set of music data belonging to each of the combined sort items, so as to integrate the entire processing.

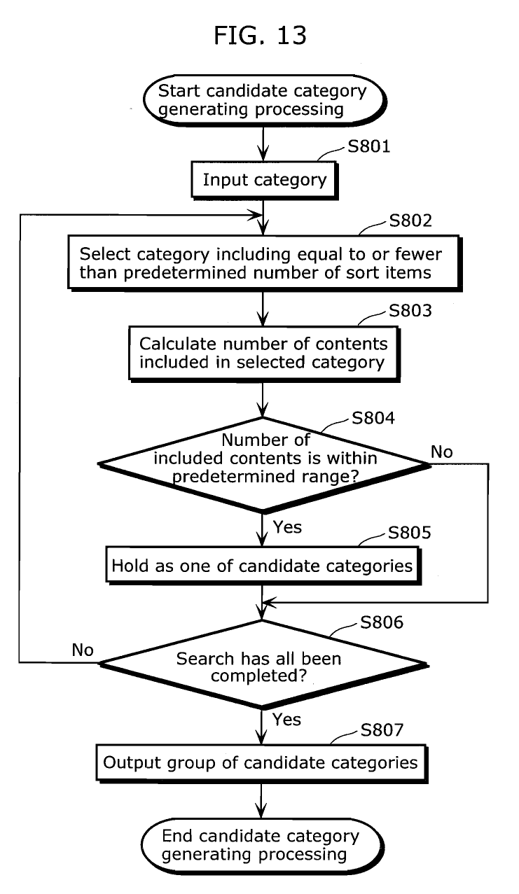

FIG. 13 is a flowchart illustrating a processing flow performed by the candidate category generating unit 141. Processing of generating a candidate category in the candidate category generating unit 141 will be described below with reference to FIG. 13.

First, categories are inputted from the category generating unit 13 (S801).

Then, a category is selected which has been generated by combining equal to or fewer than a predetermined maximum number of sort items that can be combined (S802). For example, in the case where up to “three” sort items can be combined, one, two, or three combination of sort items can be considered. It is to be noted that Step S802 can be omitted when the category generating unit 13 generates categories of only equal to or fewer than the maximum number of sort items that can be combined.

Next, a total number of pieces of music data included in the category selected in Step S802 is calculated (S803), and whether or not the total number of pieces of music data is within a predetermined range is judged (S804). In the case where the total number of pieces of music data is within a predetermined range, the process proceeds to Step S805; otherwise proceeds to S806.

The category is outputted as one of the candidate categories in Step S805, and the process proceeds to Step S806. In Step S806, whether or not the inputted categories have all been searched is judged. In the case where the search has all been completed (S806: Yes), the processing of generating candidate categories is completed. In the case where the search has not all been completed (S806: No), the process goes back to Step S802 to repeat the processes.

Finally in Step S807, all of the candidate categories generated in a series of processes are outputted as a group of candidate categories, and the processing is completed.

The candidate-category-group generating unit 142, when the candidate categories generated by the candidate category generating unit 141 have been inputted, outputs candidate category groups by grouping the candidate categories according to similarity between the music data belonging to each of the candidate categories.

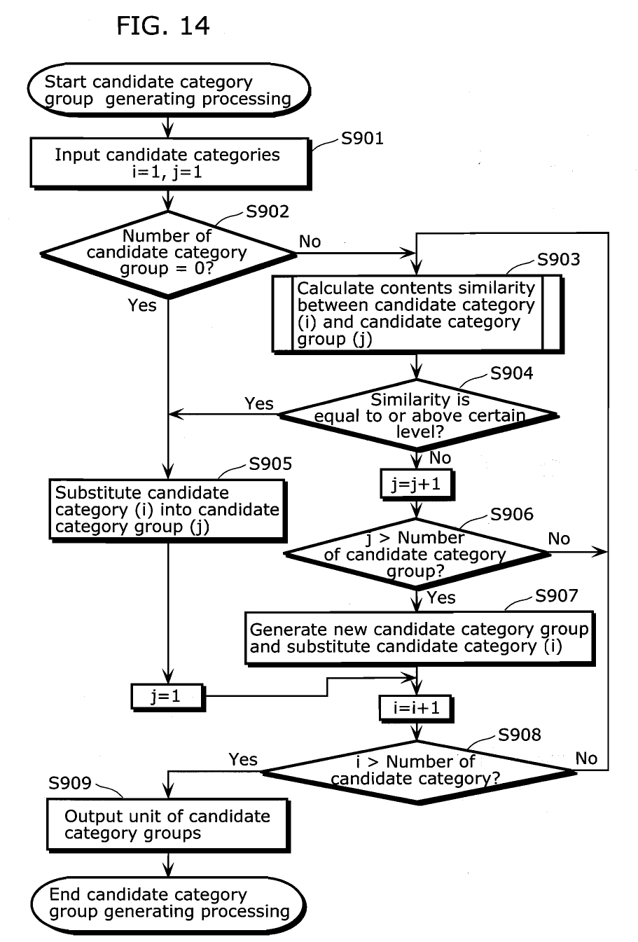

FIG. 14 is a flowchart illustrating a processing flow performed by the candidate-category-group generating unit 142. Processing of generating a group of candidate categories in the candidate-category-group generating unit 142 will be described below with reference to FIG. 14.

First, the candidate categories are inputted, and i=1 and j=1 are set (S901).

In Step S902, in the case where no candidate category group exists in the present stage, the process proceeds to Step S905, and in the case where at least one candidate category group exists, the process proceeds to Step S903.

In Step S903, an information configuration similarity between the candidate category (i) and the candidate category group (j) is calculated. The information configuration similarity is a value obtained by dividing the number of pieces of music data that belong to both the candidate category (i) and the candidate category group (j) by the number of pieces of music data that belong to candidate category (i).

In the case where the information configuration similarity is equal to or above a certain level in Step S904, the process proceeds to Step S905; otherwise 1 is added to j and the process proceeds to Step S906.

In Step S905, the candidate category (i) is added to be a member of the candidate category group (j), the music data belonging to the candidate category (i) is added to the music data belonging to the candidate category group (j), j=1 is set, 1 is added to i, and the process proceeds to Step S908.

In Step S906, whether or not j is larger than the number of candidate category groups is judged, the process proceeds to Step S907 when judged to be larger; otherwise the process proceeds to Step S903. In Step S907, a new candidate category group is generated, and the candidate category (i) is added to be a member of the newly generated candidate category group, the music data belonging to the candidate category (i) is added to the music data belonging to the newly generated candidate category group, 1 is added to i, and the process proceeds to Step S908.

In Step S908, whether or not i is larger than the number of candidate categories is judged, and when judged to be larger, the process proceeds to Step S909; otherwise proceeds to Step S903. In Step S909, all of the candidate category groups generated in a series of processes is outputted as candidate category groups, and the processing is completed.

The candidate-category-group selecting unit 143, when the candidate category groups generated by the candidate-category-group generating unit 142 has been inputted, selects a combination of candidate category groups that covers the largest number of pieces of music data, selects a representative candidate category from each of the selected candidate category groups, and outputs them as categories.

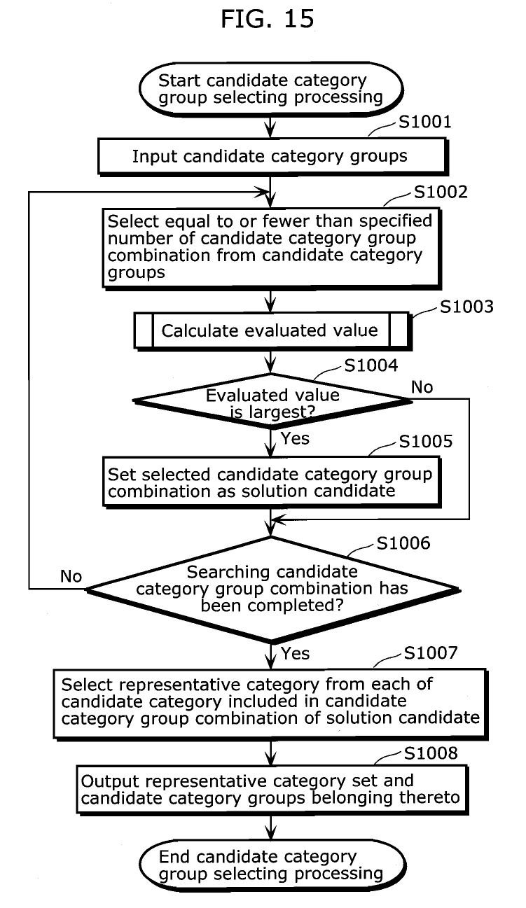

FIG. 15 is a flowchart illustrating a processing flow performed by the candidate-category-group selecting unit 143. Processing of selecting a group of candidate categories in the candidate-category-group selecting unit 143 will be described below with reference to FIG. 15.

First, the candidate category groups are inputted (S1001).

Next, candidate category groups of a number that is at least one less than a predetermined number is selected from the candidate category groups that has been inputted (S1002).

In Step S1003, an evaluated value of the combination of the selected candidate category groups is calculated. The evaluated value is the total number of pieces of music data of which overlapping is eliminated, the music data belonging to the selected candidate category groups. In Step S1004, the evaluated value calculated in the current process is judged. In the case where the evaluated value calculated in the current process is the largest in the evaluated values that have been calculated in the past processes, the process proceeds to Step S1005; otherwise proceeds to S1006.

In Step S1005, the combination of the selected candidate category groups is held as a solution candidate. In Step S1006, whether or not searching the combination of the candidate category groups has been completed is judged. In the case where the search has all been completed, the process proceeds to Step S1007, or otherwise proceeds to S1002 so as to resume searching for other combinations that have not been searched yet.

In Step S1007, a representative candidate category is selected from each of the candidate category groups included in the combination of the candidate category groups held as the solution candidate. Finally in Step S1008, a list of representative categories and a set of the candidate category groups to which the representative categories respectively belong are outputted, and the process is completed.

A method for selecting the representative candidate category includes, for example, setting, as the representative category, the top of the list of candidate categories held by each of the candidate category groups or the candidate category stored at a specified order that follows. Another method is a method using an algorithm as described below.

First, calculation is performed on each of the pieces of music data that belongs to the candidate category group including the representative category to be selected, to obtain in how many candidate categories belonging to the candidate category group the piece of music data is included. Next, an evaluated value E (k) of the kth candidate category included in the candidate category group is calculated using the following expression.

E(k)=ΣS(k,i)−n(i) [Expression 1]

Here, the S (k, i) is a value that indicates whether or not the kth candidate category includes the ith music data, and indicates “1” when the ith music data is included and indicates “0” when the ith music data is not included. The n (i) is the number of candidate categories that include the ith music data. The candidate category that has the largest evaluated value E (k) is designated as the representative category. This technique enables selecting the most general candidate category in the candidate category group.

Next, a set of the candidate category groups outputted from the candidate-category-group selecting unit 143 and a list of representative categories are inputted to the category holding unit 17 and held therein. Further, a category of “others” that is a set of music data that is not covered in the set of representative categories is generated and held.

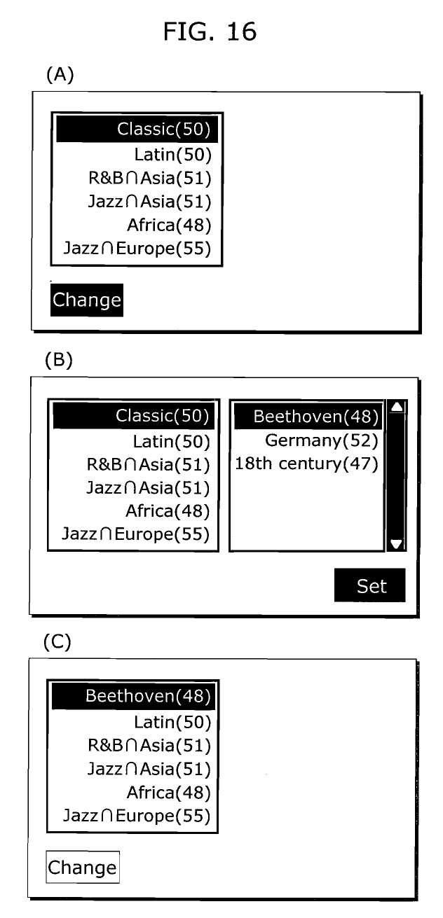

The display details arrangement unit 18 displays, on a display device, a list of representative categories as illustrated in FIG. 16(A). In some cases, it is difficult for a user to identify the details of music data included in each of the representative categories displayed on the display device. In such a case, the user can give an input for changing the representative category using the inputting unit 20.

When an instruction to change the representative category is inputted in the inputting unit 20 by the user, a list of replacement candidates for the representative category to be changed is displayed. In the case where “Classic” is to be changed in FIG. 16 (A), for example, an instruction of “Change” is executed while “Classic” is being selected. Then, a list of replacement candidates for “Classic” is displayed as illustrated in FIG. 16(B). The list of replacement candidates displayed here includes candidate categories that belong to the same candidate category group as the representative category to be replaced, among the set of the candidate category groups held in the category holding unit 17. The user selects and determines, from the list, the candidate category which the user judges to be suitable for the representative category, thereby replacing the original representative category with the selected candidate category. As illustrate in FIG. 16 (B), for example, in the case where the representative category “Classic” is to be changed to “Beethoven” that is a replacement candidate, “Beethoven” is selected and “set” is instructed. With this, “Classic” is replaced with “Beethoven” as illustrated in FIG. 16 (C).

When the representative category is replaced, there is a possibility that the music data that belongs to the representative category before replacement differs from the music data that belongs to the representative category after replacement. In the case where no difference arises, replacement is performed as it is. However, in the case where difference arises, the following processes are performed.

First, in the case where all of the music data that belongs to the representative category before replacement is included in the representative category after replacement, the representative category after replacement includes more pieces of music data. In the case where the difference music data includes the music data that belongs to “others” category, the music data is deleted from the “others” category, and the representative category is replaced.

Next, in the case where all of the music data that belongs to the representative category after replacement is included in the representative category before replacement, the representative category before replacement includes more pieces of music data. Among the difference music data, the music data that does not belong to any of the categories other than the category before replacement is added to “others” category and the representative category is replaced.

With the above described structure, the candidate category generating unit 141 searches all of the combinations that has a potential to be the category. Further, the candidate-category-group generating unit 142 groups and stores candidate categories that have a similar structure of the belonging music data. With this, it is possible to partially replace a category presented to a user with another category efficiently at high speed, while maintaining the sorting structure having less unevenness in the size between categories.

### INDUSTRIAL APPLICABILITY

The information sorting device and the information retrieval device according to the present invention have a feature that sorting having less unevenness in the size of categories is performed even in the case where information is collected on a basis of a user's taste or interest, and are useful as an information sorting device that sorts information, such as AV content accumulated in a large volume on a basis of the user's taste or interest, which includes not only music data purchased via electronic distribution or stored in a digital audio player, but also moving data recoded on a video recorder and the like or still image data such as photographs shot by a digital camera and the like, and as an information retrieval device that retrieves desired information from the sorted information. Further, the information sorting device and the information retrieval device according to the present invention can be applied to sorting and retrieving information other than AV content, such as documents and e-mails, when the information is collected on a basis of the user's taste or interest.

1. An information sorting device that sorts information, said device comprising:
an information storage unit in which information is stored;
an information extracting unit configured to extract details or attributes of the information stored in said information storage unit;
at least one sort item generating unit configured to generate a plurality of sort items based on the details or attributes of the information extracted by said information extracting unit;
a category generating unit configured to generate a category by combining one or more of the sort items generated by said sort item generating unit;
a category-combination covering amount measuring unit configured to measure a category-combination covering amount that is a total number of pieces of information that belongs to at least one of the categories composing a category combination obtained by combining a predetermined number of the categories generated by said category generating unit;
a category-size measuring unit configured to measure a size of the category generated by said category generating unit;
a category-combination searching unit configured to search a category combination having a smallest square sum of the size of the category measured by said category-size measuring unit, from among the category combinations whose category-combination covering amount measured by said category-combination covering amount measuring unit matches the total number of pieces of information stored in said information storage unit; and
a category holding unit configured to hold the category combination searched by said category-combination searching unit.

2. The information sorting device according to claim 1,
wherein said category-size measuring unit is configured to use, as the size of the category, the number of pieces of information that belongs to the category.

3. The information sorting device according to claim 1,
wherein said category-size measuring unit is configured to use, as the size of the category, a sum of numeric values corresponding to a degree of importance of the information that belongs to the category.

4. The information sorting device according to claim 1,
wherein said category generating unit is configured to generate the category by taking a union of at least two sort items.

5. The information sorting device according to claim 4,
wherein said sort item generating unit is configured to compose a broader term sharing group by combining sort items, to which information that includes details or attributes having the common broader term belongs; and
said category generating unit is configured to generate the category by identifying and combining the sort items belonging to the same broader term sharing group.

6. The information sorting device according to claim 5,
wherein said sort item generating unit is configured to compose the broader term sharing group so as to have a hierarchical structure.

7. The information sorting device according to claim 1,
wherein said category generating unit is configured to generate the category by taking a product set of at least two sort items.

8. The information sorting device according to claim 1,
wherein said information extracting unit is configured to further extract, from said information storage unit, only details or attributes of the information belonging to the category in the case where the category combination hold in said category holding unit includes the category to which more than a predetermined number of pieces of information belong.

9. The information sorting device according to claim 1,
wherein said category searching unit is configured to search, in addition to the category combinations in which a predetermined number of the categories generated by said category generating unit are combined, a combination in which one of the categories included in the category combination is replaced with an “others” category to which all of the information that does not belong to any of other categories belongs.

10. The information sorting device according to claim 1,
wherein said category-combination searching unit includes a candidate category generating unit configured to generate a candidate category by searching, from among the categories generated by said category generating unit, a category that has a category size within a predetermined range, the category size being measured by said category-size measuring unit.

11. The information sorting device according to claim 10,
wherein said category-combination searching unit further includes:
a candidate-category-group generating unit configured to generate a candidate category group by grouping the categories in which information belonging to the candidate category has a similar structure, the candidate category being generated by said candidate category generating unit, and
a candidate-category-group selecting unit configured to: generate a candidate category group combination by selecting a predetermined number of candidate category groups generated by said candidate-category-group generating unit; select one of the candidate category group combinations whose category information covering amount measured by said category-combination covering amount measuring unit matches the total number of pieces of information stored in said information storage unit; and cause said category holding unit to hold the selected combination.

12. The information sorting device according to claim 11,
wherein said candidate-category-group selecting unit, in the case where none of candidate category group combinations whose category-combination covering amount measured by said category-combination covering amount measuring unit matches the total number of pieces of information stored in said information storage unit exists, is configured to: select a candidate category group combination that has a largest category-combination covering amount; generate an “others” category to which information that is stored in said information storage unit and that does not belong to any of candidate categories is to belong; and cause said category holding unit to additionally hold the generated category.

13. The information sorting device according to claim 11,
wherein said category generating unit is configured to generate a category by combining sort items of not exceeding a predetermined number.

14. An information retrieval device that retrieves information, said device comprising:
an information storage unit in which information is stored;
an information extracting unit configured to extract details or attributes of the information stored in said information storage unit;
a sort item generating unit configured to generate a plurality of sort items based on the details or attributes of the information extracted by said information extracting unit;
a category generating unit configured to generate a category by combining one or more of the sort items generated by said sort item generating unit;
a category-combination covering amount measuring unit configured to measure a category-combination covering amount that is a total number of pieces of information that belongs to at least one of the categories composing a category combination obtained by combining a predetermined number of the categories generated by said category generating unit;
a category-size measuring unit configured to measure a size of the category generated by said category generating unit;
a category-combination searching unit configured to search a category combination having a smallest square sum of the size of the category measured by said category-size measuring unit, from among the category combinations whose category-combination covering amount measured by said category-combination covering amount measuring unit matches the total number of pieces of information stored in said information storage unit; and
a category holding unit configured to hold the category combination searched by said category-combination searching unit;
an inputting unit configured to receive, from a user, an instruction of designating a category;
a display details arrangement unit configured to arrange one of or both of the category combination held in said category holding unit and information that belongs to a category received by a user via said inputting unit so that a list of the one of or both of the category combination and the information are displayed to the user; and
a category display unit configured to display, to the user, one of or both of the category combination and the information that have been arranged by said display details arrangement unit.

15. An information sorting method of sorting information, said method comprising:
extracting details or attributes of information stored in an information storage unit;
generating, at least once, a plurality of sort items based on the details or attributes of the information extracted by said extracting;
generating a category by combining one or more of the sort items generated by said generating the plurality of sort items;
measuring a category-combination covering amount that is a total number of pieces of information that belongs to at least one of the categories composing a category combination obtained by combining a predetermined number of the categories generated by said generating the category;
measuring a size of the category generated by said generating the category;
searching a category combination having a smallest square sum of the size of the category measured by said measuring the size of the category, from among the category combinations whose category-combination covering amount measured by said measuring the category-combination covering amount matches the total number of pieces of information stored in the information storage unit; and
holding the category combination searched by said searching the category combination into a category holding unit.

16. The information sorting method according to claim 15,
wherein said searching the category combination includes generating a candidate category by searching, from among the categories generated by said generating the category, a category that has a category size of within a predetermined range, the category size being measured by said measuring the size of the category.

17. The information sorting method according to claim 16,
wherein said searching the category combination further includes:
generating a candidate category group by grouping the categories in which information belonging to a candidate category has a similar structure, the candidate category being generated by said generating the candidate category, and
selecting a candidate-category-group by: generating a candidate category group combination by selecting a predetermined number of candidate category groups generated in said generating the candidate category group; selecting one of the candidate category group combinations whose category information covering amount measured by said category-combination covering amount measuring unit matches the total number of pieces of information stored in the information storage unit; and causing the category generating unit to hold the selected combination.

18. A program for sorting information, said program causing a computer to execute:
extracting details or attributes of information stored in an information storage unit;
generating, at least once, a plurality of sort items based on the details or attributes of the information extracted by the extracting;
generating a category by combining one or more of the sort items generated by the generating the plurality of sort items;
measuring a category-combination covering amount that is a total number of pieces of information that belongs to at least one of the categories composing a category combination obtained by combining a predetermined number of the categories generated by the generating the category;
measuring a size of the category generated by the generating the category;
searching a category combination having a smallest square sum of the size of the category measured by the measuring the size of the category, from among the category combinations whose category-combination covering amount measured by the measuring the category-combination covering amount matches the total number of pieces of information stored in the information storage unit; and
holding the category combination searched by the searching the category combination into a category holding unit.

19. The program for sorting information according to claim 18,
wherein the searching the category combination includes generating a candidate category by searching, from among the categories generated by the generating the category, a category that has a category size of within a predetermined range, the category size being measured by the measuring the size of the category.

20. The program for sorting information according to claim 19,
wherein the searching the category combination further includes:
generating a candidate category group by grouping the categories in which information belonging to a candidate category has a similar structure, the candidate category being generated by the generating the candidate category, and
selecting a candidate-category-group by: generating a candidate category group combination by selecting a predetermined number of candidate category groups generated in the generating the candidate category group; selecting one of the candidate category group combinations whose category information covering amount measured by the category-combination covering amount measuring unit matches the total number of pieces of information stored in the information storage unit; and causing the category holding unit to hold the selected combination.
